(19) United States
(12) Patent Application Publication
(10) Pub. No.: US 2025/0155700 A1
(43) Pub. Date: May 15, 2025

(54) HIGH SPEED AND DURABLE SCANNING SYSTEM WITH MIRROR

(71) Applicant: VIETTEL GROUP, Ha Noi City (VN)

(72) Inventors: DANG BAN NGUYEN, Dong Hung District (VN); VAN TRONG DINH, Y Yen District (VN); DUC THUAN VU, Tu Ky District (VN)

(73) Assignee: VIETTEL GROUP, Ha Noi City (VN)

(21) Appl. No.: 18/924,438

(22) Filed: Oct. 23, 2024

(30) Foreign Application Priority Data
Nov. 15, 2023 (VN) 1-2023-08078

(51) Int. Cl. G02B 26/10; G02B 7/182; G02B 7/198; G02B 26/08

(52) U.S. Cl. CPC G02B 26/101; G02B 7/1821; G02B 7/198; G02B 26/0816

(57) ABSTRACT

The high-speed flipping mirror system consists of a reflective mirror, linear motor, flexure, position sensor, mirror mount, and sensor mount to meet the requirements of the working environment, ensuring both high-speed scanning, light of sight stabilization to serve panoramic surveillance tasks; the mechanism has a rigid structure, good stability, and high vibration and shock resistance; the mechanism is suitable for application in wide scanning electro-optical systems with stringent image sharpness requirements to perform panoramic surveillance.

### FIELD OF THE INVENTION

The invention relates to a high-speed flipping mirror system. Specifically, a controlled flat mirror used in optical system for high-speed scanning and imaging applications. The proposed invention is intended for use in the field of optoelectronics, lidar, laser communications.

### BACKGROUND OF THE INVENTION

The high-speed flipping mirror system includes key components such as a reflective mirror, linear motor, two-degree-of-freedom flexure, position sensor, mirror mount and sensor mount. These elements are integrated together with a precision mechanical system to form a complete controllable flipping mirror system. The flat mirror flipping system plays a crucial role in directing light beams from objects to the image sensor while the device carrying the sensor is mobile.

During installation, high precision is required in positioning the sensor mount relative to the linear motor mount to ensure accurate feedback of the mirror's position. Additionally, high precision in the relative position between the linear motor and the flexure is needed, as the mounting position determines the limit of the mirror's flipping angle. Under correct installation conditions, the maximum flipping angle of the reflective mirror can reach +/−2 degrees.

The flexure is a mechanical part that can bend in two perpendicular directions. It is a critical component of the high-speed flipping mirror system, providing support for the flat mirror, creating a hinge-like joint that determines the mirror's flipping angle, stability during flipping, and significantly influencing the operational lifespan of the flipping mirror system. Therefore, the flexure element must be calculated, designed and manufactured with high precision to meet the system's requirements.

### SUMMARY

The objective of the invention is to propose a high-speed flipping mirror system with a mechanism for controlling optical elements, specifically the flat mirror, according to a desired cycle and profile, thereby achieving the goal of directing or stabilizing the direction of light beams into an image sensor.

To achieve this objective, the high-speed flipping mirror system includes the following main components:

The flexure serves as a hinge structure with two rotational axes, playing a crucial role in ensuring the high-performance operation of the flipping mirror assembly. Flipping the mirror at high speeds leads to requirements for load-bearing capacity and stress concentration at the rotational axes of the flexure in the period.

To address these challenges, the design of the flexure involves calculation and selection of manufacturing materials, processing methods, and structural profiles. Each design parameter that shapes the profile of the flexure is analyzed and optimized using a multi-objective optimization approach to meet requirements for bending stiffness, torsional stiffness, stress concentration and fatigue life.

The linear motors are mounted perpendicular to the reflective mirror's surface at the four corners corresponding to the two bending directions of the flexure. When the motors move linearly in opposite pairs, they create the angular motion of the reflective mirror, referred to as the flipping process. The flipping speed depends on the speed, travel distance and acceleration of the motors.

The high-resolution position sensor determines the displacement along the linear direction of the reflective mirror's quadrants, thereby identifying the mirror's flipping angle, which serves as feedback for the system to accurately control the mirror's position along the desired path.

### BRIEF DESCRIPTION OF THE DRAWINGS

FIG. 1 is a diagram illustrating the general structure of the high-speed mirror flipping system;

FIG. 2 is a diagram showing the mirror's flipping angle;

FIG. 3 is a diagram illustrating the design components of the two-degree-of-freedom coupling (flexure);

FIG. 4 is a diagram showing the simulation results of stress concentration in the two-degree-of-freedom coupling (flexure);

FIG. 5 is a diagram illustrating the hinge axis position of the two-degree-of-freedom coupling (flexure);

FIG. 6 is a diagram illustrating the design parameters of the hinge axis in the two-degree-of-freedom coupling (flexure);

FIG. 7 is a diagram illustrating the mirror flipping control cycle; and

FIG. 8 is a diagram showing the control system layout for the mirror flipping system.

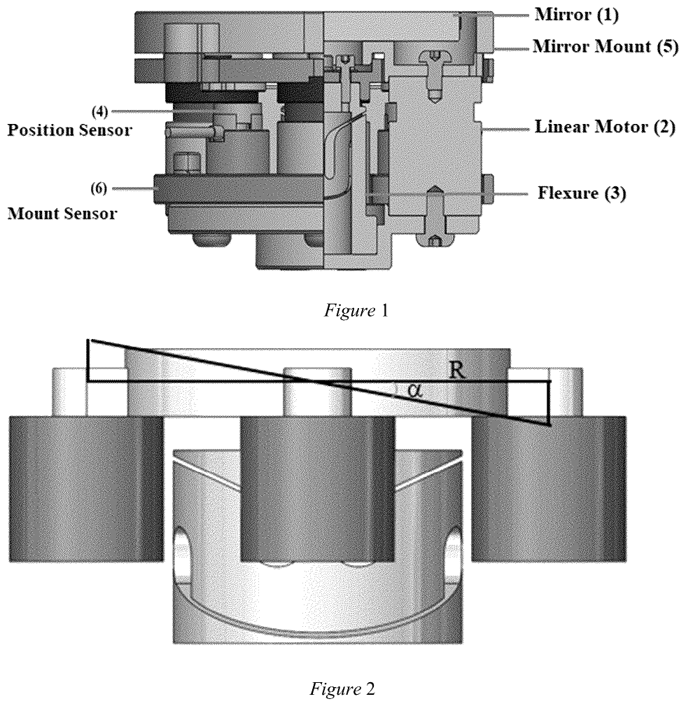

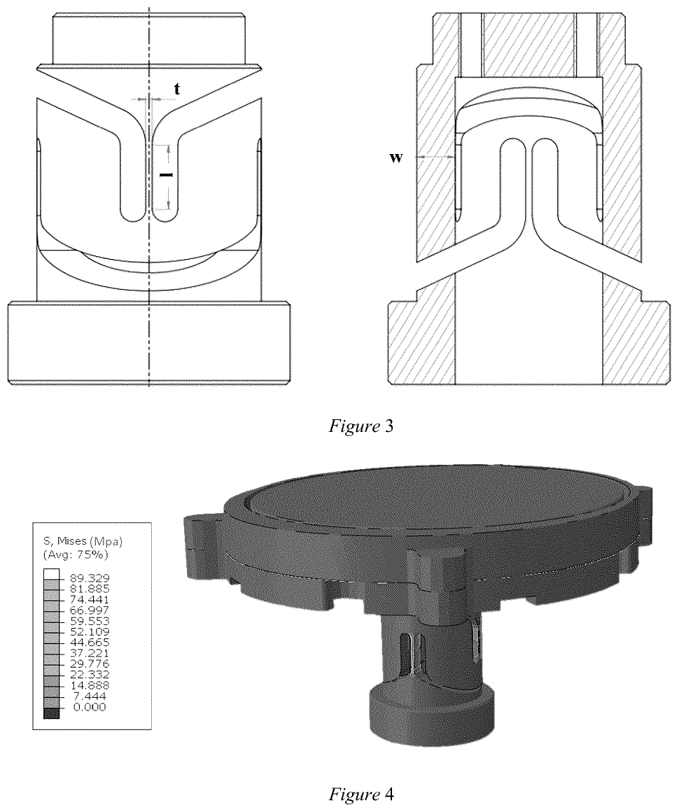

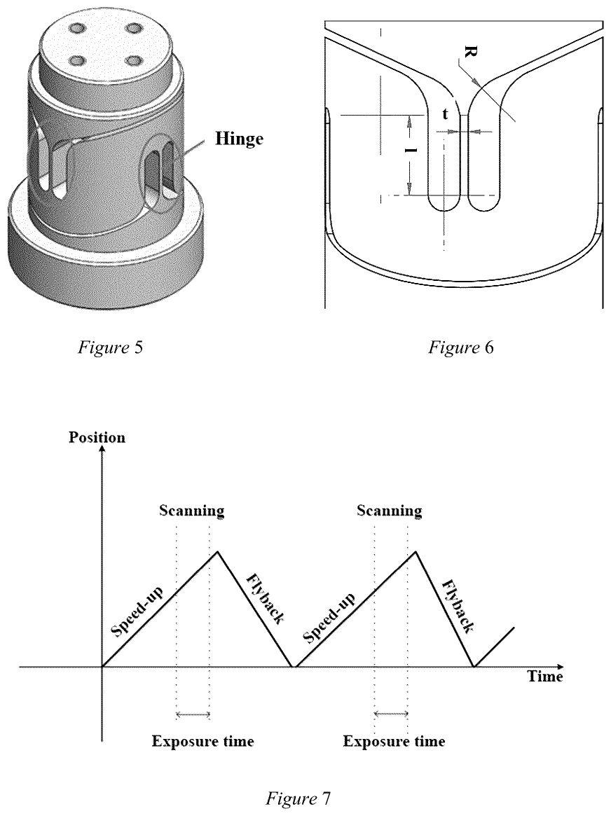

### DETAILED DESCRIPTION

Referring to FIG. 1, the high-speed flipping mirror system includes the following main components: reflective mirror 1, linear motors 2, flexure 3, position sensor 4, mirror mount 5 and sensor mount 6.

Reflective mirror 1 has a symmetrical shape, such as circular, oval, rectangular, or square, depending on the structure and installation space, and is machined to receive light from the optical lens in front and direct it to the image processing sensor behind. Reflective mirror 1 is fixedly mounted with the mirror mount 5 so that the center of the mirror and the center of the mirror mount are coaxial.

Linear motors 2, with a total of four, are divided into two pairs. The linear motors 2 are mounted perpendicularly to the mirror mount 5, all positioned on a circle, with each motor spaced 90 degrees apart, and each pair of motors symmetrically aligned across the flexure's bending direction.

The flexure 3 is machined from materials with high ductility such as aluminum alloy A7075-T6, stainless steel SUS304, titanium, etc., and is mounted with the mirror mount 5 so that the vertical axis of the mirror mount and the center of the flexure are coaxial. Additionally, along each bending direction of the flexure, a pair of linear motors 2 is symmetrically positioned on either side.

When one pair of linear motors 2 operates, one motor moves linearly upward and the other moves linearly downward, creating rotational motion around the flexure hinge for the reflective mirror 1. The flexure 3 then bends in the direction of the mirror's flip. The other pair of motors operates similarly.

The position sensor 4 is fixedly mounted to the sensor mount 6. The sensor's surface is positioned at an equal fixed distance from the reflective mirror's surface at four points. The position sensor operates on the eddy current principle, providing feedback on the mirror's position with very high accuracy, down to micro radians.

The mirror mount 5 is made from aluminum alloy and serves to securely mount the reflective mirror, linear motors, and flexure.

The sensor mount 6 is made from an electrically insulating, non-static material to ensure the reliability of the position sensor signal when operating near electromagnetic components like the linear motors 2.

Based on system requirements and position feedback signals from position sensor 4, the mirror control system applies a high-frequency control voltage to the linear actuator assembly 2. Under the condition that the system's rotation angle is mechanically limited, the mirror is required to scan at a high speed within a time equal to the exposure time of the image sensor with very high accuracy. To fulfill this requirement, the control cycle, as illustrated in FIG. 7, consists of:
Initialization: The mirror is controlled to deviate to one side of the system's 0-degree position.
Speed-up: Before the sensor starts the exposure time, the mirror's displacement gradually increases its speed to the required speed.
Scanning: The mirror moves at the required speed before the sensor exposure and maintains it throughout the exposure time.
Flyback: After sensor exposure, the mirror is controlled to return to its initial deviated position, ready for the next scanning cycle.

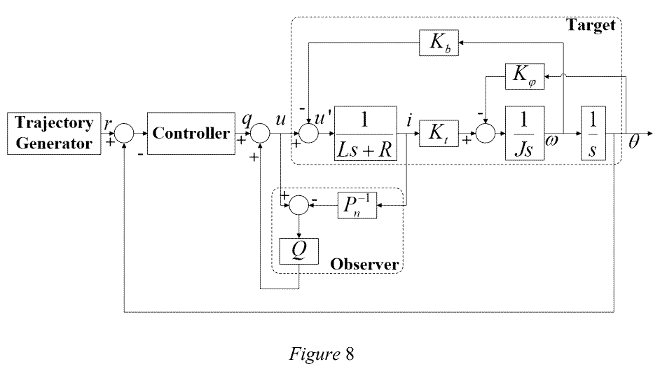

To implement the proposed cyclic control, the flipping mirror is operated in position control mode. The desired position is continuously updated for each control cycle, guaranteeing smooth and precise motion. A state observer, as illustrated in FIG. 8, is employed to detect variations in motor parameters including resistance, inductance, and electrical constant, which are caused by temperature fluctuations of the entire system over extended operation. Consequently, an appropriate voltage signal is generated to maintain control performance.

### THE EFFECTIVENESS OF THE INVENTION

The invention allows the reflective mirror to flip in a cycle at high speeds of up to 400 degrees per second with a frequency of 60 Hz continuously over a long period (at least billions of flips), enabling the direction and stability of the light beam into the image sensor during the exposure time.

The structure of the mechanism is simple, with few components, meeting the requirements for fast machining, assembly, and integration.

1. A high-speed flipping mirror system comprising components: a reflective mirror, linear motors, a flexure, a position sensor, a mirror mount, and a sensor mount:
the linear motors: consist of four motors divided into two pairs, mounted perpendicularly to the mirror mount, all positioned on a circle, with each motor spaced 90 degrees apart, and each pair of motors symmetrically aligned across a bending direction of the flexure; when the motors move linearly in opposite pairs, they create an angular motion of the reflective mirror, referred to as the mirror flipping process; the flipping speed depends on the speed, travel distance, and acceleration of the motors;
the flexure: is mounted with the mirror mount so that a vertical axis of the mirror mount and a center of the two-degree-of-freedom flexure are coincident; the flexure serves as a hinge structure with two rotational axes, playing a crucial role in ensuring the high-performance operation of the mirror flipping assembly; flipping the mirror at high speeds leads to requirements for load-bearing capacity, stiffness, and stress concentration at the flexure's rotational axes;
the reflective mirror is mounted on the mirror mount and connected to the linear motor assembly and flexure, forming a two-degree-of-freedom flipping mirror system capable of flipping in two directions, the reflective mirror has a symmetrical shape, such as circular, oval, rectangular, or square, depending on the structure and installation space, and is machined to receive light from an optical lens in front and direct it to an image processing sensor behind, the reflective mirror is fixedly mounted to the mirror mount so that a center of the mirror and a center of the mirror mount are coincident;
the high-resolution position sensor is used to determine a linear displacement of the reflective mirror's quadrants, thereby identifying the flipping angle of the mirror, which serves as feedback for a system to accurately control the mirror's position along a desired path, the position sensor is fixedly mounted on the sensor mount, with the sensor's surface positioned at an equal fixed distance from the mirror surface at four points, the position sensor operates on the eddy current principle, providing very high accuracy feedback on the mirror's position with accuracy up to micro radians;
the mirror flipping control system, based on user requirements and the position feedback signal from the position sensor, applies a control voltage to the linear motor assembly at a high frequency, in conditions where the system's rotation angle is limited by the mechanical structure, the flipping mirror system is required to flip quickly during the exposure time, with very high accuracy, to achieve this, the flipping mirror system operates according to the following cycle: the mirror is controlled to rotate to one side relative to the system's zero point; before the sensor begins an exposure time, the mirror gradually accelerates to a required speed; then, the mirror flips at the required speed before the sensor's exposure and maintains this speed throughout the exposure time; afterward, it returns to the starting point after the sensor's exposure, and the mirror is controlled to rotate back to its initial offset position, ready for the next flipping cycle.

2. The high-speed flat mirror flipping system according to claim 1, wherein the flexure material is A7075-T6, SUS304, or titanium, and the flexure's bending axis profile has an I-shape; the flexure's bending axis parameters include: a bending axis length (l); a bending axis width (t); a bending axis thickness (w); the two bending axes or rotational joints are arranged orthogonally, with the centers of the bending axes lying on the same plane.

3. The high-speed flat mirror flipping system according to claim 1, wherein the sensor mount is made from an electrically insulating, anti-static material to ensure the reliability of the position sensor signal when operating near electromagnetic components such as linear motors.
